(19) United States
(12) Patent Application Publication
(10) Pub. No.: US 2006/0072482 A1
(43) Pub. Date: Apr. 6, 2006

(54) Service routing

(75) Inventors: Dean Voiss, Mountain View, CA (US); Alex Bachmutsky, Sunnyvale, CA (US); Chi Fai Ho, Sunnyvale, CA (US); Henry Hong-Yi Tzeng, San Jose, CA (US)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/958,258

(22) Filed: Oct. 6, 2004

(51) Int. Cl. H04L 12/66; H04L 12/28

(52) U.S. Cl. 370/254

(57) ABSTRACT

The invention discloses a system, a method and a device for service switching. According to the invention, the terminal device accesses multiple services via one service access point. A service switching entity is arranged to a common network element and has further access to service providers and other service access entities. The service access entity dynamically exchanges service access information with other service access entities. After resolving the access to the desired service, the service access entity dynamically exchanges the state of the service providers. Based on the exchanged information, the service access entity applies a routing algorithm that determines the route to the desired service.

### FIELD OF THE INVENTION

The invention relates to data networking. Particularly the invention relates to service management and service switching in data communication networking.

### BACKGROUND OF THE INVENTION

The invention relates to service management and service switching. The need for efficient service switching has risen lately. Modern terminal devices are capable of using several different services simultaneously that may be implemented in different networks. For example, in mobile devices it is possible to implement different services, such as video or audio streaming and an Internet connection.

There are several problems to be solved as the number of users and services grow within networks. Provisioning and management of the services within a network and between networks grow in complexity even more rapidly than user and service growth. This rapid growth in complexity is due in part to the combinations of logical service functions and service elements that comprise a service and to that fact that a single service may actually be implemented in multiple instances of the service that are located in geographically different locations. Because of the growth in complexity it quickly becomes difficult to maintain an accurate view of the services in a network as well as accurate view links or routes needed to access those services.

Tracking and monitoring of services becomes also very complex as configuration of a network is manually or automatically adapted to relatively static or dynamic change that naturally occurs in networks. Furthermore, it is hard to maintain accurate information on what services certain network elements provide. For example, different users of the same service, such as video streaming, could use the same network elements or the same subset of network elements for a service, or even use completely different network elements for the same service.

Previously a number of approaches have been used to provide users with an access to services. Access points have been defined as part of mobile networks. An access point is a logical point at which a designated service may be obtained. The concect of access points in general has been introduced in the Open Systems Interconnection (OSI) Layer model. Typically a single access point is used to access a service available from a packet network. To provide an access to multiple services, multiple access points are configured into a mobile terminal. FIG. 1 teaches this kind of approach. The approach of FIG. 1 places the complexity of determining how to access a service in the mobile terminal or is left to the user and generally results in a significant number of access points configured on mobile terminals. Configuration of mobile terminals in such a fashion or leaving the selection up to the user has been regarded too complex by both network operators and users. Solutions based on the use of multiple access points are standards-based and currently available from most mobile network hardware vendors.

To minimize the problems mentioned above hardware vendors have defined service switching in which a single service point is used to access multiple services. This kind of solution is disclosed in FIG. 2. A drawback of this approach is that an access point selects a single network element via which all services are accessed. This implies that any services that a user wishes to access must be available via the selected network element. This works fine until the number of services and service providers supported by an operator starts to grow. Eventually the capacity of a single network element will not be sufficient to serve the desired amount of services and service providers that all users of the network would like to use. Solutions based on mapping one or more access points to access multiple services are vendor-specific rather than standards.

Service switching approaches have been used also within network elements, in which packet classification is performed using layer 3 or 4 triggers or rules. The current solutions do switch traffic to different network elements and the network elements may perform an additional classification but the access to the service as a whole is determined by a single network element. The switching services for these solutions are typically statically configured. The configuration ranges from a single or static destination IP address for the network element to a configuration where the destination IP-address for the network element is determined in a more dynamic fashion such as using load balancing algorithms.

IP routing has been defined in standards. It has been implemented by a large number of vendors. IP routing provides dynamic exchange of routing and forwarding information including reachability of various IP addresses. IP routing primarily deals with information from layer 3 in the OSI network model. Some vendors have also used layer 4 information to differentiate packets for queuing and forwarding. However, layers 5-7 are not typically used as part of forwarding decisions or route determination algorithms.

Thus, there is an obvious need for a solution that allows simple and efficient management of a large number of services.

### SUMMARY OF THE INVENTION

The invention discloses a system, a method and a device for service switching. The invention is implemented in a communication network wherein a terminal device is capable of using multiple services. According to the invention, the terminal device applies one service access point for connecting to a service switching entity. The service switching entity is arranged into a common network element and has further access to service providers, other service access entities and external service access repositories. After initiating the service, the service access entity dynamically exchanges service access information with other service access entities. After resolving the access to the desired service, the service access entity dynamically exchanges the state of the service provided via the other service access entities. Based on the exchanged information, the service access entity applies a routing algorithm that determines the route to the desired service.

The major benefit of the invention is that it provides an easy solution for using multiple services. The complexity of the configuration is moved from the terminal device to the network. A further benefit of the invention is that the service is always routed to a service provider that is capable of providing the desired service. A further benefit of the invention is that all connectivity information is exchanged dynamically. Thus, there is no need for complex and static route configurations. A further benefit of the invention is that there is a need for accesses from a single network element to all services that are provided to the customer, but the network may access the service via other service switching entities automatically.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a block diagram of a prior art solution comprising multiple service access points,

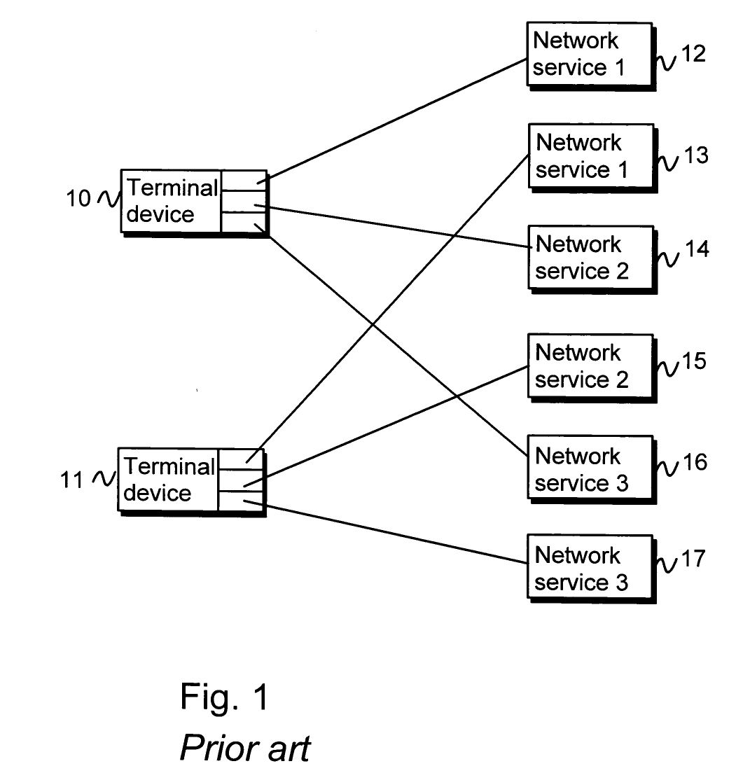

FIG. 2 is a block diagram of a prior art solution comprising single service access point,

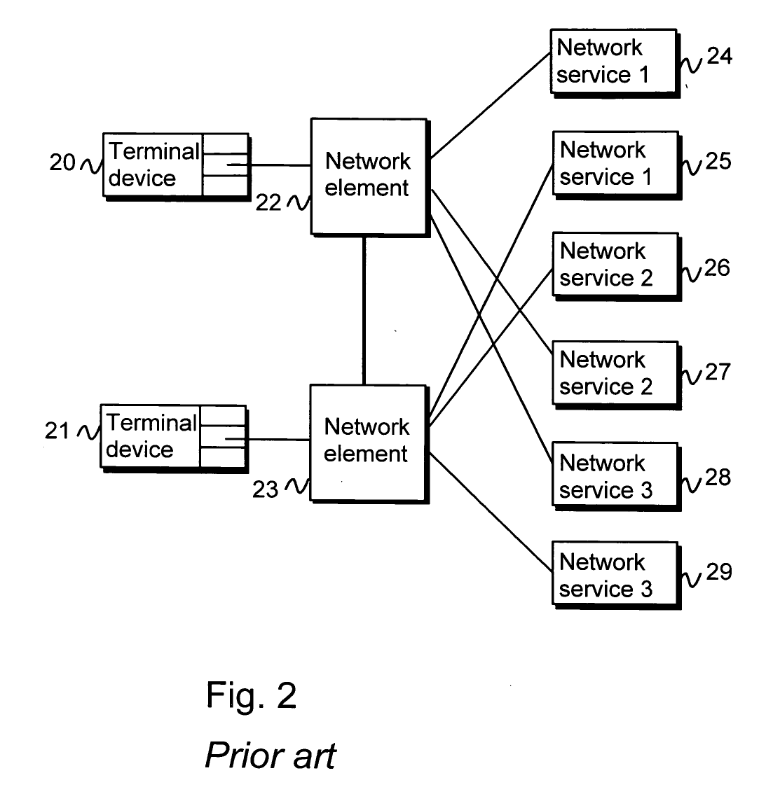

FIG. 3 is a block diagram of an example embodiment of a system according to the present invention,

FIG. 4 is a block diagram of an example embodiment of a service switching entity according to the present invention,

FIG. 5 is a flow chart of an example embodiment of the method according to the invention, and

FIG. 6 is an application of the embodiment of FIG. 3.

### DETAILED DESCRIPTION OF THE INVENTION

Reference will now be made in detail to the embodiments of the present invention, examples of which are illustrated in the accompanying drawings.

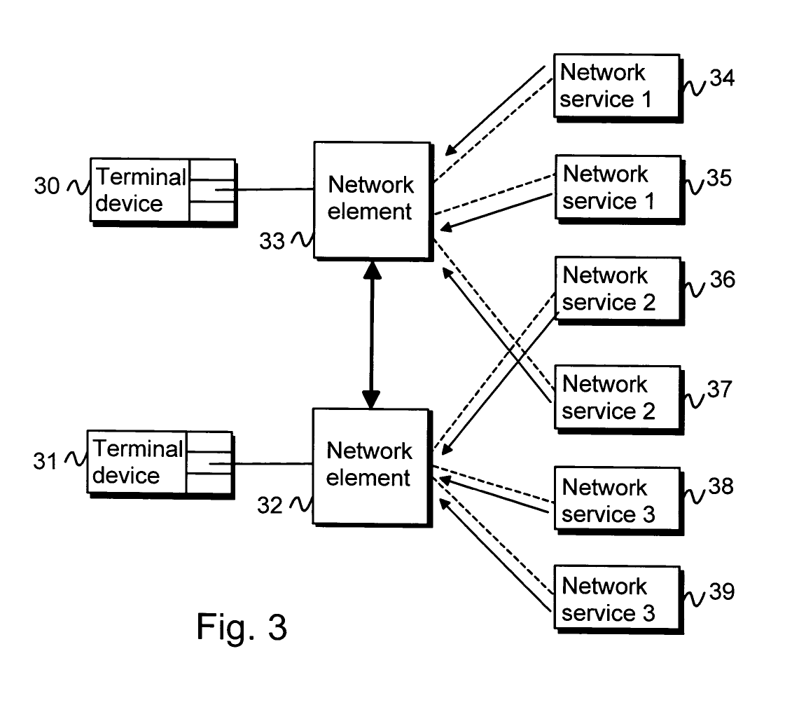

In FIG. 3 a block diagram of an example embodiment of a system according to the invention is disclosed. The system comprises terminal devices 30, 31, network elements 32, 33 including service switching capabilities and a plurality of services 34-39 implemented in the network. It is obvious to a person skilled in the art that the implemented services and the terminal device using the service may be in a different network. Thus, there might be a need for external bridges between different network technologies.

In the system according to the invention terminal devices 30 and 31 are communicating with a single network element 32 or 33. The actual communication may be provided by any known technology. Thus, the direct connection used in the example is purely for simplifying the example. A Person skilled in the art is already familiar with common data communication technologies and is aware that there might be several components between the source and the destination. Furthermore, it is also known to a person skilled in the art that it is possible to arrange communication with several network elements In the example embodiment terminal device 30 is connected to network element 33. The network element the comprises necessary functionality for transferring and routing data. Furthermore, according to the invention network elements are provided with service switching capabilities. Network elements are connected to each other and to a plurality of services. As shown in FIG. 3 all different services are not connected to every network element. In the example of FIG. 3 the third service is not accessible directly from network element 33.

In the system according to the invention the terminal device 30 first initiates service by contacting network element 33 and indicating the desired service. Network element 33 has information on other network elements and other service access repositories. The network element solves the route to the desired service by requesting the service access route. Thus, the network element does not need a full list of service access routes but only the information of other network elements. Network element needs only the addresses of network services that are connected directly to the network element. However, it is also possible to add network services dynamically to a network element 33. This is particularly case, for example, when a new service has been introduced. New service may be added manually or automatically. For example, it is possible to implement an internal trigger that searches new services and arranges old ones. It might be beneficial to establish direct connections to popular services that are accessed via other network elements. In the example it is assumed that the network element already knows the address of the desired service.

As modern services are complex, they are typically implemented in multiple instances. In FIG. 3 all services include two different instances. If terminal device 30 is willing to contact first network service instances 35, network element 33 does not need to resolve the route. As the route is known, the network element exchanges service state information. This provides up to date information about the service and about the load on the service instances. If service instance 34 has a heavy load and instance 35 has available capacity, network element 33 routes the service request to network service instance 35. If the terminal device is chosen to contact the second network service implemented in instances 36 and 37, network element 33 needs to exchange service access and service state information with network element 32 as there is no direct route from network element 33 to service instance 36. However, the basic procedure is the same as in the first case. Network element 33 makes the routing decision when it knows the route and the state of both service instances. It is possible to add decision logic so that even if service instance 36 had less load the service would be routed to instance 37 for avoiding unnecessary traffic. If terminal device 30 is willing to contact the third network service implemented in service instances 38 and 39, network element 33 needs to exchange service access and service state with network element 32. In this case there are two possible configurations. Network element 32 can be configured to make the routing decision so that it will exchange only one route to a certain service instance with network element 33 or find all possible routes and exchange all of them with network element 33.

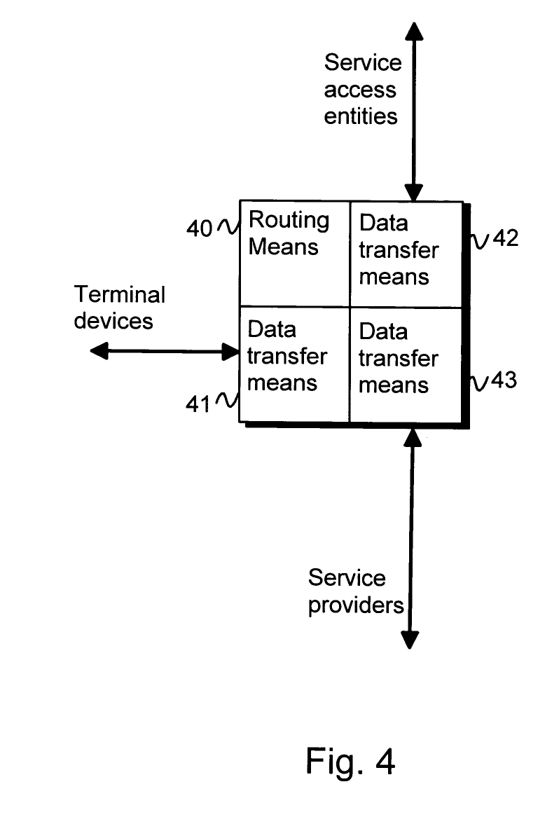

In FIG. 4 a block diagram of an example embodiment of a service switching entity according to the present invention is disclosed. The service switching entity is typically arranged into a network element so that there is no need for external service switching entity. The network element may be, for example, a gateway arranged to the network or a service node of a mobile telecommunication network. The service switching entity of the example disclosed by FIG. 4 comprises data communication means 41-43 for communicating with terminal devices, other service switching entities and actual service providers. Furthermore, service switching entity comprises service route determination means 40 for routing the desired service.

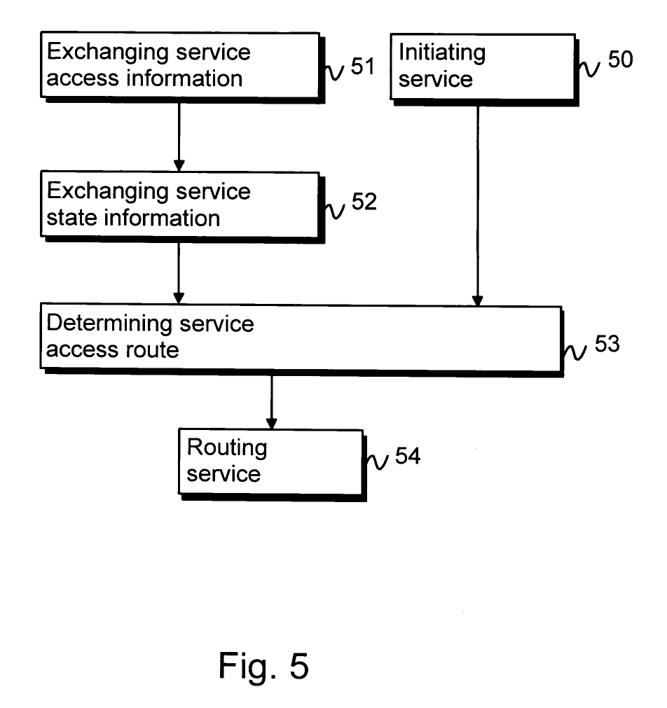

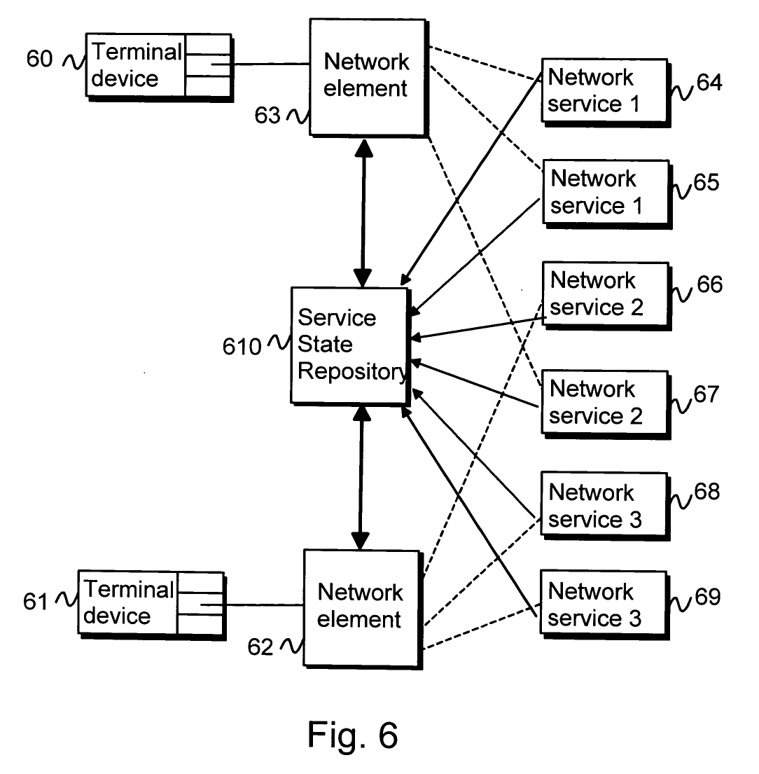

In FIG. 5 a flow chart of an example embodiment of the method according to the invention is disclosed. The method is typically carried on a service switching entity such as the service switching entity of FIG. 4. The method according to FIG. 5 is initiated by the terminal device, step 50. The terminal device contacts the service switching entity and requests the desired service. The service switching entity then resolves service access information by exchanging service access information dynamically with other service switching entities, step 51. Addresses of service access entities are configured statically so that they do not need to resolve routes to each other. After resolving the route the service access entity exchanges service state information by requesting service state dynamically from service providers, step 52. The service state request may be addressed directly to service providers or via other service switching entities. It must be noted that step 50 should be implemented to be executed in parallel with steps 51 and 52 as it is more efficient than sequential implementation. The difference between embodiments of FIGS. 3 and 6 is that in the example embodiment of FIG. 6 comprises one or more service state repositories 610. The purpose of the service state repository is to collect service state information from service providers. Thus, the service routing elements do not need to query the service state from various elements as the service state repository has collected all information. This makes finding the service provider with least load easier.

Based on the service state information, a routing decision will be made, step 53. There are several possible decision-making policies. For example, a service switching entity may choose a service provider with a low load and establish a direct connection to the service. The connection may be established also via other service switching entities. In case there are several possibilities the routing decision may be done according to the user or service provider preferences. For example, if the service provider has multiple instances and the instance with the least load requires a longer route, the route may be established to a service instance that has more load but is closer to the service switching entity. Lastly, the actual routing of the service is initiated and the terminal device is able to use the desired service, step 54.

In FIG. 6 a block diagram of a further example embodiment of a system according to the invention is disclosed. The system comprises terminal devices 60, 61, network elements 62, 63 including service switching capabilities and a plurality of services 64-69 implemented in the network. It is obvious to a person skilled in the art that the example of FIG. 6 shares most characteristics with the example of FIG. 3.

It is obvious to a person skilled in the art that with the advancement of technology, the basic idea of the invention may be implemented in various ways. The invention and its embodiments are thus not limited to the examples described above; instead they may vary within the scope of the claims.

1. A method for routing a service in a network wherein the network comprises at least one terminal device, at least one service access entity and a plurality of service providers, wherein the routing of a service from a service provider to a terminal device, the method comprising:
initiating the service by communicating with a service access entity with the terminal device;
exchanging service access information between service access entities;
exchanging service state information between service access entities and service providers;
determining a service access route based on exchanged service access and service state information; and
routing the service based on the determined service access route.

2. A method according to claim 1, wherein further comprising exchanging the service access information and the service state information in parallel with initiating the service.

3. A method according to claim 1, wherein exchanging service state information further comprises:
exchanging service state information between service access entities and a service state repository; and
exchanging service access information between the service state repository and service providers.

4. A method according to claim 1, wherein the exchanging at least one of the service access information and the service state information occurs dynamically.

5. A method according to claim 1, further comprising exchanging service access information between service access entities and external entities including a service access repository.

6. A method according to claim 1, wherein the route between service access entities is configured statically.

7. A method according to claim 1, wherein the route between service access entities and service providers is configured statically.

8. A service access entity for routing services in a network wherein the network comprises at least one terminal device, at least one service access entity and a plurality of service providers, the service access entity comprising:
a first network interface for communicating with at least one terminal device requesting at least one service;
a second network interface for communicating with at least one service access entity for exchanging service access information;
a third network interface for communicating with at least one service provider for exchanging service state information;
determining means for determining service access route based on exchanged service access and service state information; and
routing means for routing the service based on the determined service access route.

9. A service access entity according to claim 8, wherein the service access entity is configured to exchange the service access information and the service state information in parallel with initiating the service.

10. A service access entity according to claim 8, wherein the service access entity is configured to exchange service state information using a service access repository.

11. A service access entity according to claim 8, wherein the service access entity is configured to exchange at least one of the service access information and the service state information dynamically.

12. A service access entity according to claim 8, wherein the service access entity is configured to exchange service access information with external entities including a service access repository.

13. A service access entity according to claim 8, wherein the service access entity comprises statically configured routes to other service access entities.

14. A service access entity according to the claim 8, wherein the service access entity comprises statically configured routes to service providers.

15. A system for routing services in a network wherein the network comprises at least one terminal device, at least one service access entity and a plurality of service providers, the system comprising:
a terminal device for using services;
a plurality of service providers; and
at least one service access entity, the at least one service access entity comprising a first network interface for communicating with at least one terminal device requesting at least one service, a second network interface for communicating with the at least one service access entity for exchanging service access information, a third network interface for communicating with at least one service provider for exchanging service state information between a determining means and a routing means, said determining means for determining service access route based on exchanged service access and service state information and said routing means for routing the service based on the determined service access route.

16. A system according to claim 15, wherein the at least one service access entity is configured to exchange the service access information and the service state information dynamically in parallel with initiating the service.

17. A system according claim 15, further comprising a service state repository arranged between service access entities and service providers for storing service state information.

18. A system according to claim 15, wherein the at least one service access entity is configured to exchange at least one of the service access information and the service state information dynamically.

19. A system according to claim 15, wherein the at least one service access entity is configured to exchange service access information with external entities including a service access repository.

20. A system according to claim 15, wherein the at least one service access entity comprises statically configured routes to other service access entities.

21. A system according to claim 15, wherein the at least one service access entity comprises statically configured routes to service providers.

22. A computer program embodied on a computer readable medium, said computer program for routing services in a network wherein the network comprises at least one terminal device, at least one service access entity and a plurality of service providers, wherein the computer program performs the following steps when executed in a data-processing device:
receiving the service initialization from a terminal device;
exchanging service access information between service access entities;
exchanging service state information between service access entities and service providers;
determining service access route based on exchanged service access and service state information; and
routing the service based on the determined service access route.

23. A computer program according to claim 22, wherein the computer program further comprises code to perform the following steps when executed in a data-processing device:
exchanging the service access information and the service state information in parallel with initiating the service.

24. A computer program according to claim 22, wherein the computer program further comprises code to perform the following steps when executed in a data-processing device:
exchanging service state information between service access entities and a service state repository; and
exchanging service access information between the service state repository and service providers.

25. A computer program according to claim 22, wherein the computer program further comprises code to perform the following steps when executed in a data-processing device:
exchanging at least one of the service access information and the service state information dynamically.

26. A computer program according to claim 22, wherein the computer program further comprises code to perform the following steps when executed in a data-processing device:
exchanging service access information between service access entities and external entities including a service access repository.

27. A computer program according to claim 22, wherein the computer program further comprises code to perform the following steps when executed in a data-processing device:
configuring route between service access entities statically.

28. A computer program according to claim 22, wherein the computer program further comprises code to perform the following steps when executed in a data-processing device:
configuring the route between service access entities and service providers statically.
